(19) United States
(12) Patent Application Publication
(10) Pub. No.: US 2022/0237073 A1
(43) Pub. Date: Jul. 28, 2022

(54) INFORMATION PROCESSING APPARATUS, NON-TRANSITORY COMPUTER READABLE MEDIUM STORING PROGRAM, AND METHOD

(71) Applicant: FUJIFILM Business Innovation Corp., Tokyo (JP)

(72) Inventor: Eiji MIYAMAE, Kanagawa (JP)

(73) Assignee: FUJIFILM Business Innovation Corp., Tokyo (JP)

(21) Appl. No.: 17/406,101

(22) Filed: Aug. 19, 2021

(30) Foreign Application Priority Data
Jan. 26, 2021 (JP) 2021-010332

(51) Int. Cl. G06F 11/07

(52) U.S. Cl. CPC G06F 11/0793; G06F 11/0778; G06F 11/0751; G06F 11/073

(57) ABSTRACT

An information processing apparatus includes a processor configured to: store a plurality of logs respectively associated with an importance in a buffer, the logs being generated by executing an application program; extract only a log associated with the importance equal to or greater than a predetermined level from logs which have been stored in the buffer for over a predetermined period, and store the extracted log in a first memory; and, in a case where the logs stored in the buffer include a fault log satisfying a condition indicating a fault, store one or more logs corresponding to the fault log among the logs stored in the buffer, in a second memory.

### CROSS-REFERENCE TO RELATED APPLICATIONS

This application is based on and claims priority under 35 USC 119 from Japanese Patent Application No. 2021-010332 filed Jan. 26, 2021.

### BACKGROUND

### (i) Technical Field

The present invention relates to an information processing apparatus, a non-transitory computer readable medium storing a program, and a method.

### (ii) Related Art

For example, in JP2002-215431A discloses an information processing apparatus as follows. A trace information accumulation function unit provided in an execution program body sequentially stores an execution history and a processing status as trace information in a trace information storage region in an internal memory, during an execution of a program. In a case where an event notification of a fault occurring is received from a system monitoring mechanism, a trace information output function unit provided in the execution program body outputs the trace information accumulated in the trace information storage region in the internal memory to one of trace information files placed in an external storage device.

JP2004-139483A discloses an output method of log information as follows. A log output program receives log information from an application program process, and only contents having a log level which is equal to or smaller than a log level predetermined at the time of start are written in a general output log file. All pieces of log information are recorded in a log buffer for a fault occurrence time so that detailed information at the time of a fault occurring remains. Then, only the log information of the process in which a fault occurs is output to a log file for a fault occurrence time.

### SUMMARY

Aspects of non-limiting embodiments of the present disclosure relate to an information processing apparatus, a non-transitory computer readable medium storing a program, and a method that are capable of decreasing the required storage capacity in comparison to a case where all logs are continuously stored, and, providing a log required for investigating the cause in a case where a fault occurs.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: store a plurality of logs respectively associated with an importance in a buffer, the logs being generated by executing an application program; extract only a log associated with the importance equal to or greater than a predetermined level from logs which have been stored in the buffer for over a predetermined period, and store the extracted log in a first memory; and, in a case where the logs stored in the buffer include a fault log satisfying a condition indicating a fault, store one or more logs corresponding to the fault log among the logs stored in the buffer, in a second memory.

### BRIEF DESCRIPTION OF THE DRAWINGS

Exemplary embodiment(s) of the present invention will be described in detail based on the following figures, wherein:

FIG. 1 is a diagram illustrating an example of an overall configuration of an information processing system 9;

FIG. 2 is a diagram illustrating an example of a configuration of an information processing apparatus 1;

FIG. 3 is a schematic diagram illustrating an example of a buffer 121;

FIG. 4 is a diagram illustrating an example of a log;

FIG. 5 is a diagram illustrating an importance;

FIG. 6 is a diagram illustrating an example of a setting table 122;

FIG. 7 is a diagram illustrating an example of a definition DB 123;

FIG. 8 is a diagram illustrating an example of a pattern ID list 1231;

FIG. 9 is a diagram illustrating an example of a condition table 1232;

FIG. 10 is a diagram illustrating an example of a handling table 1233;

FIGS. 11A and 11B are diagrams illustrating an example of a status table 124;

FIG. 12 is a diagram illustrating an example of a configuration of a terminal 2;

FIG. 13 is a diagram illustrating an example of a configuration of a server device 4;

FIG. 14 is a diagram illustrating an example of a functional configuration of the information processing apparatus 1;

FIG. 15 is a flowchart illustrating an example of an operation flow of storing a log in the buffer;

FIG. 16 is a flowchart illustrating an example of an operation flow of extracting a log; and

FIG. 17 is a flowchart illustrating an example of an operation flow of detecting a fault log.

### DETAILED DESCRIPTION

### Exemplary Embodiment

Overall Configuration of Information Processing System

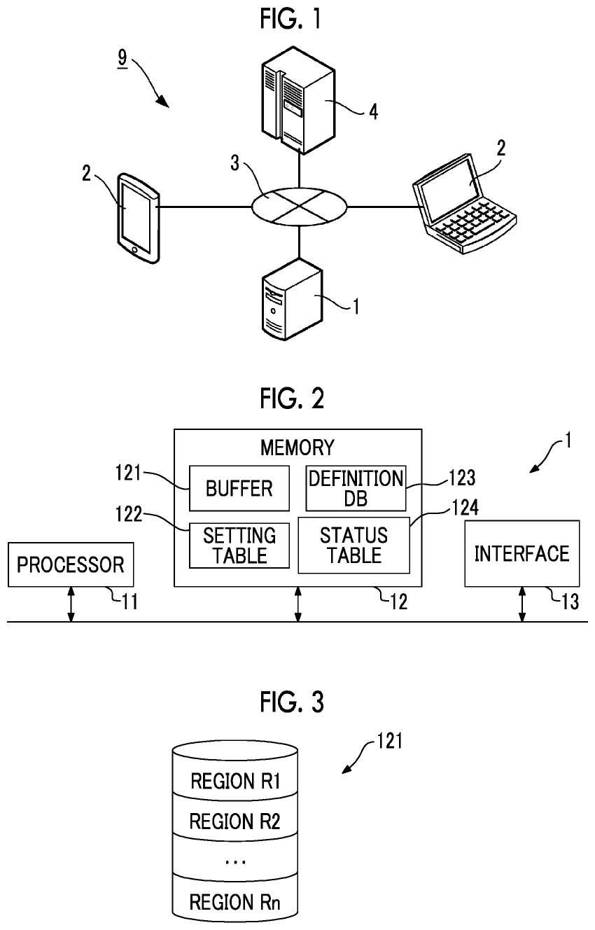

FIG. 1 is a diagram illustrating an example of an overall configuration of an information processing system 9. The information processing system 9 illustrated in FIG. 1 includes an information processing apparatus 1, a terminal 2, a communication line 3, and a server device 4.

The terminal 2 is a device possessed and used by each user of the information processing system 9. Examples of the terminal 2 include a personal computer, a slate PC, a tablet terminal, and a smartphone. The terminal 2 illustrated in FIG. 1 causes the information processing apparatus 1 to manage documents.

The communication line 3 is a line for communicably connecting the components of the information processing system 9 to each other. The communication line 3 illustrated in FIG. 1 may be, for example, a local area network (LAN), a wide area network (WAN), the Internet, or a combination thereof.

The information processing apparatus 1 is a device operated from the terminal 2 via the communication line 3 to provide a service in response to a request from the terminal 2. For example, the information processing apparatus is a computer. The information processing apparatus 1 illustrated in FIG. 1 manages documents such as drawings and contract documents in response to a request from the terminal 2, and stores the state of the information processing apparatus by the management.

The server device 4 is a device that provides information stored in response to a request from the information processing apparatus 1 and the terminal 2, and is, for example, a web server. A mail server, a domain name server, and the like are also connected to the communication line 3 of the information processing system 9 illustrated in FIG. 1.

Configuration of Information Processing Apparatus

FIG. 2 is a diagram illustrating an example of a configuration of the information processing apparatus 1. The information processing apparatus 1 illustrated in FIG. 2 includes a processor 11, a memory 12, and an interface 13.

The processor 11 reads and executes a program stored in the memory 12, and thereby controls the units of the information processing apparatus 1. The processor 11 is, for example, a central processing unit (CPU).

The interface 13 is a communication circuit that communicably connects the information processing apparatus 1 to the communication line 3 and other devices in a wired or wireless manner.

The memory 12 is a storage unit that stores an operating system read into the processor 11, application programs (simply referred to as applications below) that function in accordance with various uses, and other types of data. The memory 12 includes a random access memory (RAM) and a read only memory (ROM). The memory 12 may include a solid state drive, a hard disk drive, or the like. The memory 12 stores a buffer 121, a setting table 122, a definition DB 123, and a status table 124.

FIG. 3 is a schematic diagram illustrating an example of the buffer 121. The buffer 121 is a region in which a log generated by the processor 11 executing an application is stored in association with an importance of the log. The log generated by the processor 11 is information indicating the state of the information processing apparatus 1 and the like due to the execution of the application.

The buffer 121 illustrated in FIG. 3 is divided into n regions (n is an integer of 3 or more) of a region R1, a region R2, . . . , and a region Rn. The “i” of the region Ri is an integer from 1 to n, and is a number indicating the order of the plurality of regions of the buffer 121. In this order, for the number other than n (being the maximum number), the next number is defined as the next largest number so that the order of 1 is 2, the order of 2 is 3, and the like. In addition, the order is defined so that the number next to n is 1 being the minimum number. That is, the order circulates. That is, the buffer 121 illustrated in FIG. 3 is an example of a buffer having a plurality of regions to which a circulating order is assigned.

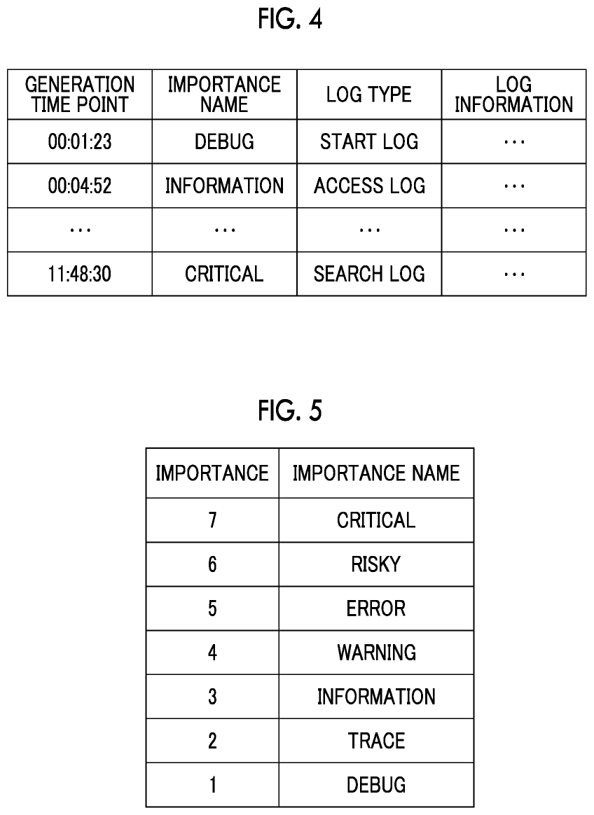

FIG. 4 is a diagram illustrating an example of a log. For example, the log illustrated in FIG. 4 is stored in any region Ri of the buffer 121 described above. The log illustrated in FIG. 4 has items of a generation time point, an importance name, log type, and log information.

The log generation time illustrated in FIG. 4 is information indicating a time point at which the processor 11 generated the log. The importance name is a text string indicating the name of the importance of the log. The log type is a text string indicating the type of the log. The log information is information indicating the contents of the log itself indicating the state and the like of the information processing apparatus 1. Information of the four items is associated with one log.

FIG. 5 is a diagram illustrating the importance. The importance illustrated in FIG. 5 is a number indicating the degree of importance of the log, and is indicated by a number from 1 to 7. The greater the importance, the more important the log is. An importance name is assigned to each of seven kinds of importance. That is, for example, a log associated with the importance name “critical” is the most important log, and a log associated with the importance name “debug” is the least important log. The smaller the importance, the more detailed the log information is. That is, in a case where it is intended to obtain detailed information from a log, not only a log having a high importance but also a log having a lower importance (that is, more detailed log) is required.

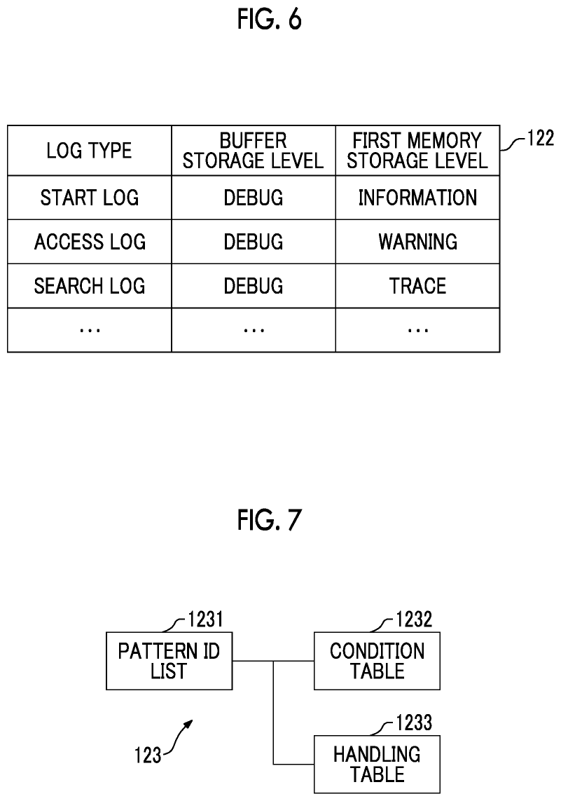

FIG. 6 is a diagram illustrating an example of the setting table 122. The setting table 122 is a table in which the lower limit of the levels of logs stored in the buffer 121 and a first memory 421 of the server device 4 described later is defined. The setting table 122 illustrated in FIG. 6 has items of a log type, a buffer storage level, and a first memory storage level.

The log type is information indicating the type of the log, and is, for example, “start log”, “access log”, “search log”, and the like. The buffer storage level is information indicating the level of the importance of the log stored in the buffer 121. The first memory storage level is information indicating the level of the importance of the log stored in the first memory 421 described above.

For example, in the setting table 122 illustrated in FIG. 6, the buffer storage level is “debug” regardless of the log type. This means that the log is stored in the buffer 121 so long as the log has an importance which is equal to or greater than “debug”. As illustrated in FIG. 5, “debug” is the least importance name. That is, in this case, the buffer 121 stores all logs regardless of the log type and the importance.

In the setting table 122 illustrated in FIG. 6, regarding the first memory storage level, “information” is assigned to “start log”, “warning” is assigned to “access log”, and “trace” is assigned to “search log”. This means that the first memory 421 stores a log associated with the importance which is equal to or greater than a different level for each log type.

For example, regarding the log having a log type of “start log”, only a log associated with the fifth importance which is equal to or higher than the importance having an importance name “information” is stored in the first memory 421, and other logs are not stored. Regarding the log having a log type of “access log”, only a log associated with the fourth importance which is equal to or higher than the importance having an importance name “warning” is stored in the first memory 421, and other logs are not stored.

Although the setting table 122 illustrated in FIG. 6 has the log type item, one buffer storage level and one first memory storage level may be set regardless of the log type.

FIG. 7 is a diagram illustrating an example of the definition DB 123. The definition DB 123 is a database that defines a condition indicating that a fault has occurred in the information processing apparatus 1. Here, the “fault” is an event satisfying the condition defined in the definition DB 123. Therefore, for example, the so-called “normal operation” defined by an operation condition of the information processing apparatus 1, a timing of an instruction received from the terminal 2, and the operation time is also handled as a “fault” by defining the condition.

A log satisfying the condition defined by the definition DB 123 is referred to as a “fault log”. In a case where the information processing apparatus 1 detects a fault log, one or more logs corresponding to the fault log are extracted from the buffer 121 and stored in a second memory 422 of the server device 4, which will be described later. The definition DB 123 illustrated in FIG. 7 has a pattern ID list 1231, a condition table 1232, and a status table 124.

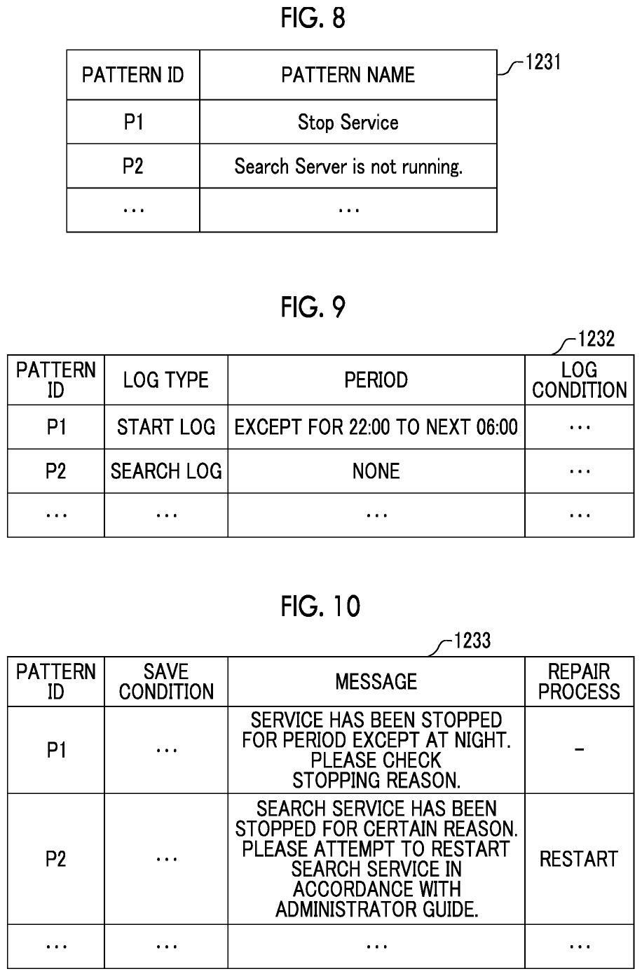

FIG. 8 is a diagram illustrating an example of the pattern ID list 1231. In the pattern ID list 1231 illustrated in FIG. 8, a pattern ID and a pattern name are stored in association with each other. The pattern ID is identification information for identifying each pattern of the fault log generated in a case where a fault has occurred. The pattern name is the name of the pattern identified by the corresponding pattern ID.

FIG. 9 is a diagram illustrating an example of the condition table 1232. The condition table 1232 is a table in which the condition indicating the pattern of the corresponding fault log is associated and stored for each pattern ID described in the pattern ID list 1231. The condition is the content itself of the pattern identified by the pattern ID, and has items of the log type, a period, and a log condition.

In the condition table 1232, the log type indicates the log type of the fault log forming the above-described pattern. In the condition table 1232, the period indicates the period during which the above-described pattern appears. In the condition table 1232, the log condition is a condition indicating the characteristics of the fault log, which are included in the above-described pattern. The log condition is defined by, for example, a text and symbols included in log information, a text and symbols not included in the log information, and the like. In a case where the pattern is configured by a plurality of logs, the log condition may be defined by the order or the interval in which the plurality of logs are generated.

FIG. 10 is a diagram illustrating an example of the handling table 1233. The handling table 1233 is a table in which a handling method of the fault indicated by the pattern identified by a pattern ID is associated and stored for each pattern ID described in the pattern ID list 1231. The handling method has items of a save condition, a message, and a repair process.

In the handling table 1233 illustrated in FIG. 10, the save condition is information indicating the condition of a log to be stored (also referred to as saved) in the second memory 422, corresponding to the fault log included in the pattern identified by the pattern ID. The log satisfying the save condition is transmitted to the server device 4 and stored in the second memory 422.

Logs satisfying the save condition are one or more logs corresponding to the fault log and may not coincide with the fault log. Therefore, for example, a log which is generated before or after the fault log and is not the fault log may be included. The logs satisfying the save condition may or may not have the generation time points which are continuous with the generation time point of the fault log. The logs satisfying the save condition may be configured only by any of logs before or logs after the generation of the fault log or both the logs generated before and after the generation of the fault log. The save condition is defined in advance by the designer as a condition to be satisfied by a log required for investigating the cause of the fault indicated by the fault log.

The save condition may be satisfied by a log associated with the importance lower than the first memory storage level. In this case, the one or more logs corresponding to the fault log are an example of one or more logs including logs associated with the importance lower than a predetermined level.

The save condition may be a log continuously generated before or after the fault log. In this case, the one or more logs corresponding to the fault log are a plurality of continuous logs before or after the fault log. The save condition may be a log generated continuously both before and after the fault log.

In the handling table 1233 illustrated in FIG. 10, the message is a text string or the like indicating a message of which a user is notified in a case where the fault of the pattern identified by the pattern ID has occurred. For example, in a case where the pattern indicated by the pattern ID “P1” is detected, the information processing apparatus 1 notifies the terminal 2 of the user of a message indicating that “the service has stopped except at night. Please check the stopping reason”.

In the handling table 1233 illustrated in FIG. 10, the repair process is information indicating a process of repairing the fault of the pattern identified by the pattern ID. In a case where “−” is described in the field of the repair process, the repair process is not defined, and the information processing apparatus 1 does not perform the repair process of repairing the fault. In a case where information other than “−” is described in the field of the repair process, the information processing apparatus 1 performs the repair process in accordance with the information. For example, in a case where the information processing apparatus 1 detects the pattern indicated by the pattern ID “P2” in the handling table 1233 illustrated in FIG. 10, the information processing apparatus 1 restarts the information processing apparatus 1.

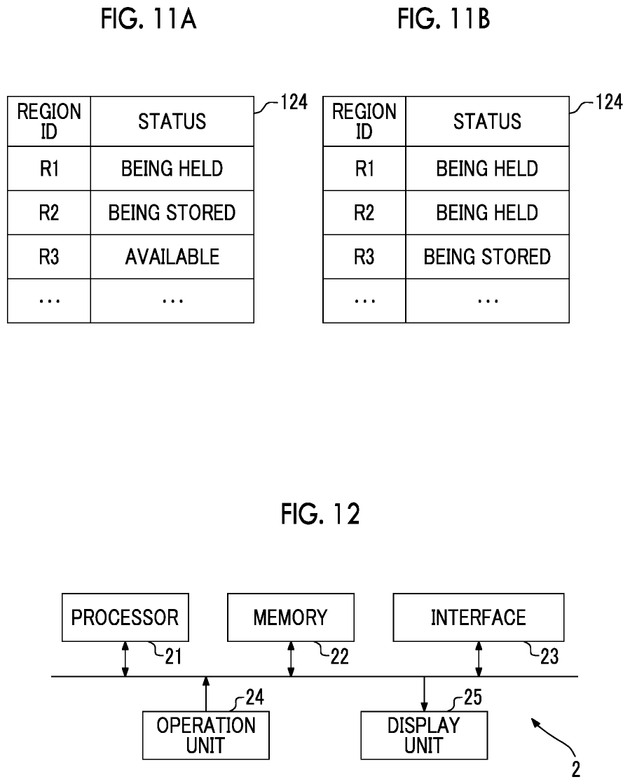

FIGS. 11A and 11B are diagrams illustrating an example of the status table 124. The status table 124 is a table in which the current status of each of a plurality of divided regions of the buffer 121 is stored. The status table 124 illustrated in FIGS. 11A and 11B has items of a region ID and a status. The region ID in the status table 124 is identification information for identifying each of a plurality of regions of the buffer 121 illustrated in FIG. 3. The status in the status table 124 is information indicating the current status of the region identified by the corresponding region ID.

In FIGS. 11A and 11B, the status includes at least three types being “being held”, “being stored”, and “available”. “Being held” is a status indicating that the region is in a held state in which storing of a new log storage is not accepted and is not released. “Being stored” is a status indicating that the region is in a state of accepting storing of a new log. “Available” is a status indicating that the region is neither held nor stored and is in a state where storing of a new log can be accepted. The statuses of all regions in the initial state and the region “being held” at the time of being released are changed to “available”.

The status of each region of the buffer 121 transitions in the order of available→being stored→being held→available. In the initial state, the information processing apparatus 1 sets the statuses of all the regions of the buffer 121 to “available”. The information processing apparatus 1 starts storing of a log, for example, from the region of the region ID “R1”. The status of the region of the region ID “R1” of which storing has been started is changed from “available” to “being stored” in the status table 124.

In a case where there is no free space to store a new log in the region of the region ID “R1”, the information processing apparatus 1 changes the status of this region from “being stored” to “being held”. In addition, the information processing apparatus changes the status of the region of the region ID “R2”, which is the next region, from “available” to “being stored” and starts storing of a log in this region. At this time, the status table 124 is in the state illustrated in FIG. 11A.

In a case where the information processing apparatus 1 continuously stores logs in the region of the region ID “R2” and the free space in this region is exhausted, the information processing apparatus 1 changes the status of this region from “being stored” to “being held”, and then changes the status of the region of the region ID “R3”, which is the next region, from “available” to “being stored” and starts storing of a log in this region. At this time, the status table 124 is in the state illustrated in FIG. 11B.

In a case where all the regions of the buffer 121 have no free space for storing new logs, the information processing apparatus 1 extracts only a log associated with the importance which is equal to or greater than the first memory storage level stored in the setting table 122, from one region (for example, region of the region ID “R1” in FIG. 11B) in which the oldest log is stored among all the regions. Then, the information processing apparatus 1 stores the extracted log in the first memory 421. In a case where the information processing apparatus 1 completes the extraction and the storing into the first memory 421, the information processing apparatus 1 releases the “one region” as the extraction target, and changes the status of this region from “being held” to “available”.

The processor 11 of the information processing apparatus 1 that stores logs in the buffer 121 in the above-described operation by using the status table 124 illustrated in FIGS. 11A and 11B is an example of a processor that selects one region having a free space for storing a generated log among a plurality of regions, in order, and stores a log in the selected one region.

Configuration of Terminal

FIG. 12 is a diagram illustrating an example of a configuration of the terminal 2. The terminal 2 illustrated in FIG. 12 includes a processor 21, a memory 22, an interface 23, an operation unit 24, and a display unit 25.

The processor 21 reads and executes a program stored in the memory 22, and thereby controls the units of the terminal 2. The processor 21 is, for example, a CPU.

The interface 23 is a communication circuit that communicably connects the terminal 2 to the communication line 3 and other devices in a wired or wireless manner.

The memory 22 is a storage unit that stores an operating system, various programs, other types of data, and the like read into the processor 21. The memory 22 includes a RAM and a ROM. The memory 22 may include a solid state drive, a hard disk drive, or the like.

The operation unit 24 includes an operation tool for issuing various instructions, such as operation buttons, a keyboard, a mouse, and a touch panel. The operation unit receives an operation and transmits a signal corresponding to the operation content to the processor 21.

The display unit 25 displays the designated image under the control of the processor 21. The display unit 25 illustrated in FIG. 12 includes a liquid crystal display which is a display screen for displaying the above-described image. A transparent touch panel of the operation unit 24 may be superposed on the liquid crystal display.

Configuration of Server Device

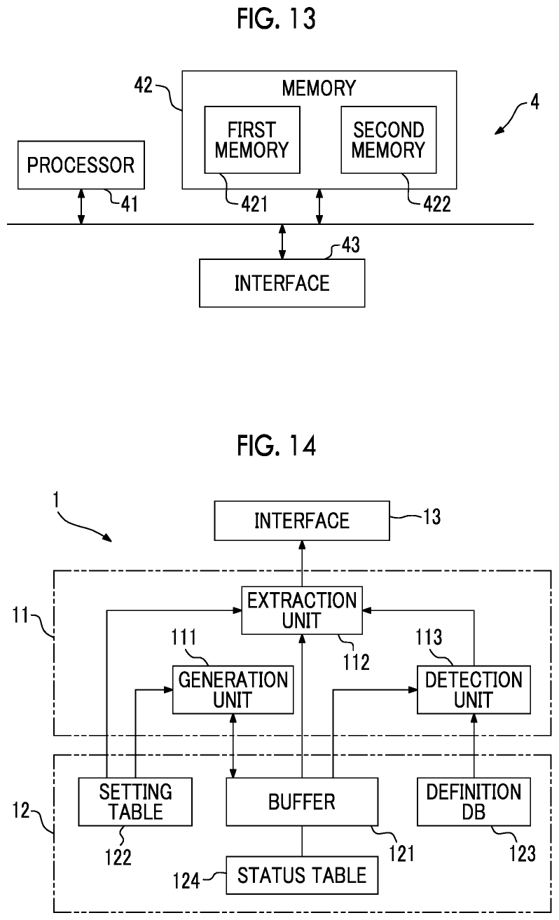

FIG. 13 is a diagram illustrating an example of a configuration of the server device 4. The server device 4 illustrated in FIG. 13 includes a processor 41, a memory 42, and an interface 43.

The processor 41 reads and executes a program stored in the memory 42, and thereby controls the units of the server device 4. The processor 41 is, for example, a CPU.

The interface 43 is a communication circuit that communicably connects the server device 4 to the communication line 3 and other devices in a wired or wireless manner.

The memory 42 is a storage unit that stores an operating system, various programs, other types of data, and the like read into the processor 41. The memory 42 includes a RAM and a ROM. The memory 42 may include a solid state drive, a hard disk drive, or the like.

The memory 42 includes the first memory 421 and the second memory 422. The first memory 421 is a memory region for storing only a log associated with the importance which is equal to or greater than the first memory storage level stored in the setting table 122 among logs which have been stored in the buffer 121 for over a predetermined period. The second memory 422 is a memory region for storing one or more logs corresponding to the fault log in a case where the fault log is stored in the buffer 121.

The server device 4 is a web server. The server device receives an instruction to store a log, from the information processing apparatus 1 via the communication line 3, and stores the log in the first memory 421 or the second memory 422 in response to the instruction. In a case where the server device 4 stores the log, the server device may notify the information processing apparatus 1 of the identification information indicating the region in which the log is stored.

In a case where the server device 4 receives a log request together with the identification information indicating the region in which the log is stored, from the terminal 2 via the communication line 3, the server device reads the log from the region indicated by the identification information and provides the log for the terminal 2. The identification information received from the terminal 2 with the log request is, for example, a uniform resource identifier (URI). In a case where the user transmits a hypertext transfer protocol (HTTP) request in which the URI is designated, from the terminal 2 to the server device 4, the server device 4 generates an HTTP response in response to the HTTP request and transmits the HTTP response to the terminal 2 as a request source.

Functional Configuration of Information Processing Apparatus

FIG. 14 is a diagram illustrating an example of a functional configuration of the information processing apparatus 1. The processor 11 of the information processing apparatus 1 executes a program stored in the memory 12 to function as a generation unit 111, an extraction unit 112, and a detection unit 113.

In a case where the processor 11 executes an application, the generation unit 111 generates a log indicating the state of the information processing apparatus 1 by the execution of the application. The generation unit 111 refers to the status table 124 to select any of the plurality of regions of the buffer 121, and then stores the generated log in the selected region in association with the importance of the log. The log stored in the buffer 121 is associated with the importance which is equal to or greater than the buffer storage level stored in the setting table 122. That is, the processor 11 functioning as the generation unit 111 is an example of a processor that stores a log associated with an importance in a buffer, the log being generated by executing an application program.

In a case where the selected area has no free space for storing a new log, the generation unit 111 changes the status table 124 and selects the next region. Then, the generation unit 111 stores the above-described log in the selected region in association with the importance of the above log.

The extraction unit 112 extracts only a log associated with the importance which is equal to or greater than a predetermined level among the logs stored in the buffer 121. The extraction is performed on the log stored in the buffer 121 which have been stored for over a predetermined period, among the logs stored in the buffer 121.

For example, in a case where all the regions of the buffer 121 have no free space for storing new logs, the extraction unit 112 extracts only a log associated with the importance which is equal to or greater than the first memory storage level stored in the setting table 122, from one region in which the oldest log is stored, among the regions of the buffer 121. In this case, the above-described period is a period from storing of the log as a target of the extraction in the buffer 121 until all the regions have no free space.

The extraction unit 112 transmits the extracted log to the server device 4 via the interface 13 and instructs the server device 4 to store the extracted log in the first memory 421. The server device 4 stores the log transmitted by the extraction unit 112 in the first memory 421 in accordance with the above-described instruction.

That is, the processor 11 functioning as the extraction unit 112 is an example of a processor that extracts only a log associated with the importance equal to or greater than a predetermined level from logs which have been stored in the buffer for over the predetermined period, and stores the extracted log in the first memory.

In a case where the extraction of the log associated with the importance which is equal to or greater than the first memory storage level is ended, the extraction unit 112 releases the one region described above. The status of this “one region” which has been released is changed to “available”. The generation unit 111 selects the released one region and stores a new log in the selected region in association with the importance of the stored log.

That is, the processor 11 functioning as the generation unit 111 and the extraction unit 112 is an example of a processor that, in a case where none of the plurality of regions has the free space, extracts only a log associated with the importance equal to or greater than the predetermined level from one region in which the oldest log is stored, stores the extracted log in the first memory, releases and selects the one region, and stores the generated log in the one region.

The detection unit 113 detects the fault log satisfying the condition defined in the definition DB 123, from the buffer 121. In a case where the logs stored in the buffer 121 include the fault log, the detection unit 113 instructs the extraction unit 112 to extract one or more logs corresponding to the fault log.

In a case where the above-described instruction is received from the detection unit 113, the extraction unit 112 extracts one or more logs corresponding to the fault log, from the buffer 121. The extraction unit 112 transmits the extracted one or more logs to the server device 4 via the interface 13 and instructs the server device 4 to store the extracted logs in the second memory 422. The server device 4 stores the one or more logs transmitted by the extraction unit 112, in the second memory 422 in accordance with the above-described instruction.

That is, the processor 11 functioning as the extraction unit 112 and the detection unit 113 is an example of a processor that, in a case where the logs stored in the buffer include a fault log satisfying a condition indicating a fault, stores one or more logs corresponding to the fault log among the logs stored in the buffer, in the second memory.

In a case where the extraction unit 112 receives the above-described instruction from the detection unit 113, the extraction unit may store one or more logs corresponding to the fault log, in the second memory 422 of the server device 4, and may acquire information on the fault indicated by the condition satisfied by the fault log and the identification information of the region in which the fault log is stored in the second memory 422, and notify the user of the acquired information. The information on the fault of which the notification is issued is, for example, a message described in the handling table 1233 in the definition DB 123. This notification is performed, for example, by E-mail or the like using a mail server, a domain name server, or the like connected to the communication line 3.

In this case, the processor 11 functioning as the extraction unit 112 is an example of a processor that stores the one or more logs corresponding to the fault log satisfying the condition, in the second memory, and notifies a user of information on the fault indicated by the condition and identification information of the second memory.

In a case where the repair process is defined in the condition satisfied by the detected fault log in the definition DB 123, the detection unit 113 may attempt to perform the repair process. In this case, the processor 11 functioning as the detection unit 113 is an example of a processor that stores one or more logs corresponding to the fault logs satisfying the condition in the second memory and attempts to repair the fault indicated by the condition.

Operation of Information Processing Apparatus

By executing the above-described program, the information processing apparatus 1 realizes an operation of storing a log in the buffer, an operation of extracting a log of a predetermined level or higher, and an operation of detecting a fault log.

Operation of Storing Log in Buffer

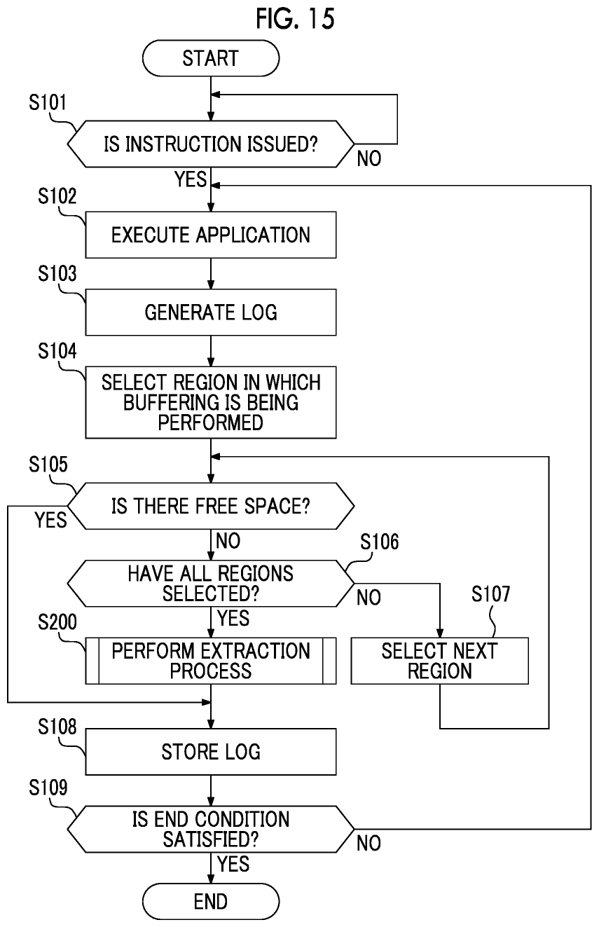

FIG. 15 is a flowchart illustrating an example of an operation flow of storing a log in the buffer by the processor 11. In a case where the information processing apparatus 1 is started, the processor 11 monitors the interface 13 and determines whether or not the terminal 2 issues an instruction to execute the application from the user (Step S101). While determining that there is no instruction (Step S101; NO), the processor 11 continues this determination.

In a case where the processor 11 determines that the above-described instruction is issued (Step S101; YES), the processor 11 executes the application being the instruction target (Step S102), and generates a log indicating the state of the information processing apparatus 1 by the execution of the application (Step S103).

In a case where the log is generated, the processor 11 selects a region for storing the log from the plurality of regions of the buffer 121 (Step S104). The processor 11 determines whether or not there is a free space for storing the log in the selected region (Step S105).

In a case where the processor 11 determines that there is no free space (Step S105; NO), the processor 11 determines whether or not all the regions of the buffer 121 have been selected (Step S106). In a case where the processor 11 determines that not all regions have been selected (Step S106; NO), the processor 11 selects the next region (Step S107) and causes the process to return to Step S105.

In a case where the processor 11 determines that all regions have been selected (Step S106; YES), the processor 11 performs a predetermined extraction process (Step S200), thereby selecting a new region. The processor 11 stores the new log generated in Step S103 in the selected region as a result of the extraction process (Step S108). Step S200 will be described later.

In a case where the processor 11 determines in Step S105 that there is the free space (Step S105; YES), the processor 11 stores the above-described log in this region determined to have the free space (Step S108).

In the flowchart illustrated in FIG. 15, the logs generated in Step S103 are sequentially stored in the buffer 121 in Step S108 each time the logs are generated. The generated logs may not be sequentially stored in the order of being generated. For example, each of the logs illustrated in FIG. 4 includes a generation time point which is a so-called time stamp. Therefore, for example, even through two or more generated logs are stored in the buffer 121 at a common timing, the information of the order of the logs is not lost.

The processor 11 determines whether or not the end condition of the application is satisfied (Step S109). In a case where the processor 11 determines that the end condition is not satisfied (Step S109; NO), the processor 11 causes the process to return to Step S102.

In a case where the processor 11 determines that the end condition of the application is satisfied (Step S109; YES), the processor 11 ends the process.

Operation of Extracting Log

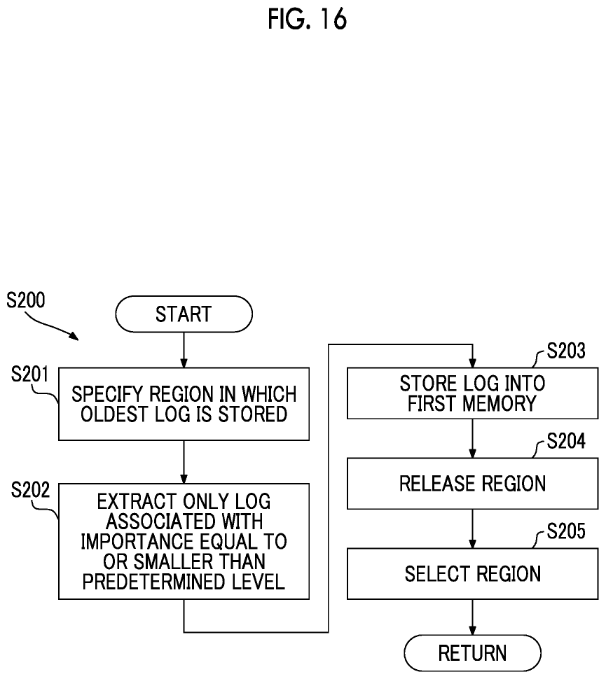

FIG. 16 is a flowchart illustrating an example of an operation flow of extracting a log by the processor 11. The processes from Step S201 to Step S205 illustrated in FIG. 16 form the extraction process of Step S200 illustrated in FIG. 15.

The processor 11 specifies a region in which the oldest log is stored among the plurality of regions of the buffer 121 (Step S201). Then, the processor 11 extracts only a log associated with the importance which is equal to or greater than the first memory storage level shown in the setting table 122, among logs stored in the specified region (Step S202).

In a case where the above-described log is extracted, the processor 11 transmits the log to the server device 4 and instructs the server device 4 to store the log in the first memory 421 (Step S203). Then, the processor 11 releases the region specified in Step S201 (Step S204), newly selects the released region (Step S205), and causes the process to return a step of calling extraction process.

Operation of Detecting Fault Log

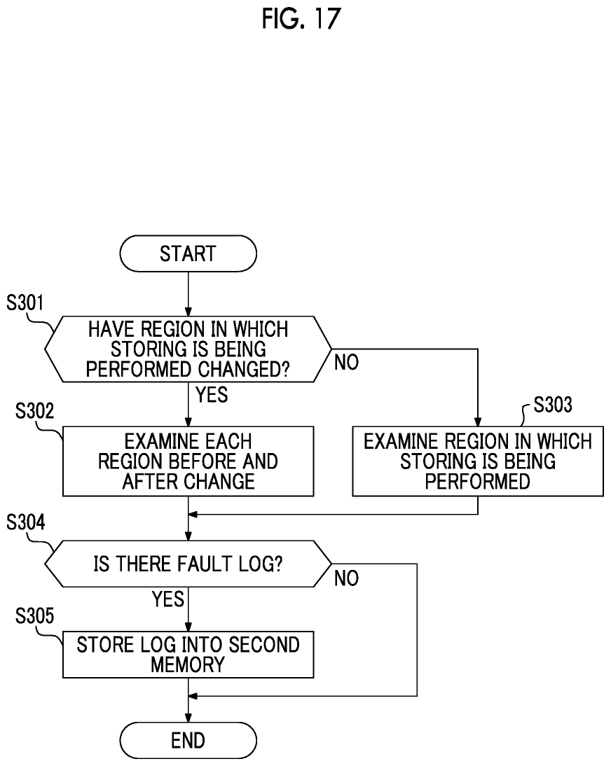

FIG. 17 is a flowchart illustrating an example of an operation flow of detecting a fault log by the processor 11. The operation illustrated in FIG. 17 is performed in parallel with the operation of storing the log in the buffer illustrated in FIG. 15, and is called and performed at a cycle determined by, for example, a timer or the like.

The processor 11 refers to the status table 124 to determine whether or not the region during storing has changed by comparison with the previous time (Step S301). The region during storing is a region which is selected by the processor 11 as a region for storing the log and has a status changed to “being stored” in the status table 124.

In a case where the processor 11 determines that the region during storing has changed (Step S301; YES), the processor 11 determines whether or not the fault log is provided in one region having the status that indicates being currently during storing, and one region having the status that indicates being during storing in the previous time. That is, the processor 11 examines each region before and after the change (Step S302).

Here, determination of whether or not the there is the fault log, immediately after the region during storing is changed is determination of first whether or not logs stored in one region selected last include the fault log. In this case, the processor 11 examines each of the one region selected last and the one region previously selected.

Therefore, the processor 11 is an example of a processor that, in a case where it is determined first whether or not the logs stored in the one region selected last include the fault log, determines whether or not logs stored in each of the one region and a region selected before the one region include the fault log.

In a case where the processor 11 determines that the region during storing is not changed (Step S301; NO), the processor 11 examines the one region having the status which is currently during storing (Step S303).

The processor 11 determines whether or not there is the fault log as a result of the examination in Step S302 or Step S303 (Step S304). In a case where the processor 11 determines that there is no fault log (Step S304; NO), the processor 11 ends the process. In a case where the processor 11 determines that there is the fault log (Step S304; YES), the processor 11 refers to the definition DB 123 to specify one or more logs satisfying the save condition, which correspond to the detected fault log. Then, the processor 11 transmits the specified logs to the server device 4 and stores the logs in the second memory 422 (Step S305). In this example, the processor 11 transmits all logs in the region determined to have the fault log as “one or more logs satisfying the save condition, which correspond to the detected fault log”, to the server device 4, and stores the logs in the second memory 422.

Thus, the processor 11 is an example of a processor that, in a case where logs stored in one region selected last include the fault log, stores one or more logs corresponding to the fault log in the second memory.

With the above-described operation, the information processing apparatus 1 may reduce the required storage capacity in comparison to a case where all the logs generated by the execution of the application are continuously stored. The information processing apparatus 1 stores the log before the fault occurs, in the buffer for a predetermined period. Thus, in a case where the fault has occurred, it is possible to extract the log required for investigating the cause and provide the log.

### Modification Examples

The exemplary embodiment has been described above, but the content of the exemplary embodiment may be modified as follows. The modification examples as follows may be combined with each other.

1

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

2

In the above-described exemplary embodiment, the processor 11 of the information processing apparatus 1 determines whether or not the region during storing has changed in comparison to the previous time, and determines the region as a target of examining whether or not there is the fault log, in accordance with the result, but may determine the above region in accordance with another determination result.

For example, the processor 11 may determine whether or not the quantity of logs stored in the region currently during storing is smaller than the threshold value, and determine the region as the target of examining whether or not there is the fault log, in accordance with the result. In a case where the processor 11 determines that the quantity of logs stored in one region having the state which is currently during storing is smaller than the threshold value, in addition to this one region, the processor sets one region having the status which has been during storing in the previous time, to be the examination target of the fault log.

That is, in this case, the processor 11 is an example of a processor that, in a case where the quantity of logs stored in the one region selected last is smaller than the threshold value, determines whether or not logs stored in each of the one region and a region selected before the one region include the fault log. According to this configuration, the processor 11 examines whether or not the fault log is included in logs of which the quantity is equal to or greater than the threshold value.

3

In the above-described exemplary embodiment, the information processing apparatus 1 causes the server device 4 being an external web server to store a log associated with the importance which is equal to or greater than the predetermined level and one or more logs corresponding to the fault log. The information processing apparatus 1 may store at least some of the above logs in the information processing apparatus 1. That is, the buffer, the first memory, and the second memory may be the memories of the identical device. In this case, the information processing apparatus 1 may function as a web server.

4

In the above-described exemplary embodiment, the first memory 421 and the second memory 422 are stored in the memory 42 of one server device 4, but may be stored in different server devices 4, respectively. The server device may be realized by, for example, a so-called cloud computing service in which a plurality of computers cooperate to realize the function of a web server or the like.

5

In the above-described exemplary embodiment, the program executed by the processor 11 of the information processing apparatus 1 is an example of a program causing a computer having a processor to perform a step of storing a plurality of logs respectively associated with an importance in a buffer, the log being generated by executing an application program, a step of extracting only a log associated with the importance equal to or greater than a predetermined level from logs which have been stored in the buffer for over a predetermined period, and storing the extracted log in a first memory, and a step of, in a case where the logs stored in the buffer include a fault log satisfying a condition indicating a fault, storing one or more logs corresponding to the fault log among the logs stored in the buffer, in a second memory.

The program may be provided in a state of being stored in a recording medium that can be read by a computer device, such as a magnetic recording medium such as a magnetic tape and a magnetic disk, an optical recording medium such as an optical disk, an optical magnetic recording medium, and a semiconductor memory. The program may be downloaded via a communication line such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
store a plurality of logs respectively associated with an importance in a buffer, the logs being generated by executing an application program;
extract only a log associated with the importance equal to or greater than a predetermined level from logs which have been stored in the buffer for over a predetermined period, and store the extracted log in a first memory; and
in a case where the logs stored in the buffer include a fault log satisfying a condition indicating a fault, store one or more logs corresponding to the fault log among the logs stored in the buffer, in a second memory.

2. The information processing apparatus according to claim 1,
wherein the one or more logs corresponding to the fault log include a log associated with the importance lower than the level.

3. The information processing apparatus according to claim 1,
wherein the one or more logs corresponding to the fault log are a plurality of continuous logs before or after the fault log.

4. The information processing apparatus according to claim 2,
wherein the one or more logs corresponding to the fault log are a plurality of continuous logs before or after the fault log.

5. The information processing apparatus according to claim 1, wherein the processor is configured to:
store the one or more logs corresponding to the fault log satisfying the condition, in the second memory, and, notify a user of information on the fault indicated by the condition and identification information of the second memory.

6. The information processing apparatus according to claim 2, wherein the processor is configured to:
store the one or more logs corresponding to the fault log satisfying the condition, in the second memory, and, notify a user of information on the fault indicated by the condition and identification information of the second memory.

7. The information processing apparatus according to claim 3, wherein the processor is configured to:
store the one or more logs corresponding to the fault log satisfying the condition, in the second memory, and, notify a user of information on the fault indicated by the condition and identification information of the second memory.

8. The information processing apparatus according to claim 4, wherein the processor is configured to:
store the one or more logs corresponding to the fault log satisfying the condition, in the second memory, and, notify a user of information on the fault indicated by the condition and identification information of the second memory.

9. The information processing apparatus according to claim 1, wherein the processor is configured to:
store the one or more logs corresponding to the fault log satisfying the condition, in the second memory, and, attempt to repair the fault indicated by the condition.

10. The information processing apparatus according to claim 2, wherein the processor is configured to:
store the one or more logs corresponding to the fault log satisfying the condition, in the second memory, and, attempt to repair the fault indicated by the condition.

11. The information processing apparatus according to claim 3, wherein the processor is configured to:
store the one or more logs corresponding to the fault log satisfying the condition, in the second memory, and, attempt to repair the fault indicated by the condition.

12. The information processing apparatus according to claim 4, wherein the processor is configured to:
store the one or more logs corresponding to the fault log satisfying the condition, in the second memory, and, attempt to repair the fault indicated by the condition.

13. The information processing apparatus according to claim 5, wherein the processor is configured to:
store the one or more logs corresponding to the fault log satisfying the condition, in the second memory, and, attempt to repair the fault indicated by the condition.

14. The information processing apparatus according to claim 6, wherein the processor is configured to:
store the one or more logs corresponding to the fault log satisfying the condition, in the second memory, and, attempt to repair the fault indicated by the condition.

15. The information processing apparatus according to claim 1,
wherein the buffer includes a plurality of regions to which a circulating order is assigned, and
the processor is configured to:
select one region having a free space for storing the generated log among the plurality of regions in the order and store the log in the one region; and
in a case where none of the plurality of regions has the free space, extract only a log associated with the importance equal to or greater than the level from one region in which the oldest log is stored, store the extracted log in the first memory, release and select the one region, and store the generated log in the one region.

16. The information processing apparatus according to claim 15, wherein the processor is configured to:
in a case where logs stored in the one region selected last include the fault log, store the one or more logs corresponding to the fault log in the second memory.

17. The information processing apparatus according to claim 16, wherein the processor is configured to:
in a case where it is determined first whether or not the logs stored in the one region selected last include the fault log, determine whether or not logs stored in each of the one region and a region selected before the one region include the fault log.

18. The information processing apparatus according to claim 16, wherein the processor is configured to:
in a case where a quantity of the logs stored in the one region selected last is smaller than a threshold value, determine whether or not logs stored in each of the one region and a region selected before the one region include the fault log.

19. A non-transitory computer readable medium storing a program causing a computer having a processor to execute a process comprising:
storing a plurality of logs respectively associated with an importance in a buffer, the logs being generated by executing an application program;
extracting only a log associated with the importance equal to or greater than a predetermined level from logs which have been stored in the buffer for over a predetermined period, and storing the extracted log in a first memory; and
in a case where the logs stored in the buffer include a fault log satisfying a condition indicating a fault, storing one or more logs corresponding to the fault log among the logs stored in the buffer, in a second memory.

20. A method comprising:
storing a plurality of logs respectively associated with an importance in a buffer, the logs being generated by executing an application program;
extracting only a log associated with the importance equal to or greater than a predetermined level from logs which have been stored in the buffer for over a predetermined period, and storing the extracted log in a first memory; and
in a case where the logs stored in the buffer include a fault log satisfying a condition indicating a fault, storing one or more logs corresponding to the fault log among the logs stored in the buffer, in a second memory.
